(19) United States
(12) Patent Application Publication
(10) Pub. No.: US 2006/0088396 A1
(43) Pub. Date: Apr. 27, 2006

(54) ADA compliant element

(76) Inventor: Ray A. Thom, Castalia, OH (US)

Correspondence Address: DONALD R. SCHOONOVER, 4211 ROLLING HILLS DRIVE, NIXA, MO, 65714-8771, US

(21) Appl. No.: 10/969,312

(22) Filed: Oct. 21, 2004

(51) Int. Cl. F16B 1/00

(52) U.S. Cl. 411/80.1

(57) ABSTRACT

An element has a body that is mounted in concrete and a head. The body and the head have co-linear bores, and an expander pin is accommodated in the aligned bores. The expander pin has a head with a color that is identical to the color of the head of the element body, and the color of the head of the element body is selected according to a contrast percent determined according to C=100{(B1−B2)/B1}, where C=contrast, B1=light reflectance value (LRV) of the head of the body, and B2=light reflectance value (LRV) of the substrate in which the element body is located.

### BACKGROUND OF THE INVENTION

1. Field of the Invention

The present invention relates to the general art of static structures, and to the particular field of elements for use on static structures.

2. Discussion of the Related Art

In order to conform to the requirements of the Americans With Disabilities Act (ADA) of 1990, many places that are open to the public must accommodate the needs of people with disabilities. For example, places such as shopping malls and grocery stores, and the like, should have parking spaces for disabled people as well as restrooms with features such as raised toilets, grab bars, a large stall that can accommodate a wheelchair and a sink that can be easily reached by someone using a wheelchair. In addition, other buildings which are open to the public should be equipped with wheelchair ramps, elevators with raised markings on the elevator buttons, and curb cuts in sidewalks and entrances.

However, the installing of wheelchair ramps can have problems. A wheelchair ramp, for example, can be expensive to install and can experience weather-related damage. In addition, some communities replace old ramps with new concrete and ADA buttons embossed in the surface of the concrete. However, these buttons are usually uncolored, thereby making them more difficult to detect.

Therefore, there is a need for an element that is used for ramps associated with ADA compliance and which complies with ADA requirements.

The element should be easy and expeditious to install, even if a multiplicity of elements must be installed in a special pattern.

Therefore, there is a need for an element that is used on ramps associated with ADA compliance and which complies with ADA requirements and which can be expeditiously installed.

The ADA requires detectable warnings at various locations, such as crossing walks, and the like. These detectable warnings must conform to certain visibility and size standards. It is often difficult and expensive to install such warnings or to retrofit areas to include such warnings. This can be burdensome on State and Local Governments as well as on businesses and home owners.

Therefore, there is a need for a warning that complies with the requirements of the ADA yet which is not overly-burdensome to install.

In the past, some sort of protuberance has been used in a surface so a visually disabled person can feel a designated area. However, such protuberances have been difficult to install, difficult to maintain, and difficult and expensive to replace. Installation and maintenance of such protuberances often requires special skills and special tools, which makes such activities difficult and expensive, often requiring specially trained workers. This is especially onerous if the protuberances are in difficult-to-access locations.

Therefore, there is a need for a warning that complies with the requirements of the ADA yet which is easy to install, maintain, and replace.

Still further, the inventor is not aware of an such protuberance that has a color contrast between the protuberance and the support in which it is located. This results in the protuberance being both unsightly as well as difficult to see.

Therefore, there is a need for a warning that complies with the requirements of the ADA yet which is easy to install, maintain and replace, and is still easy to see and can be attractive if desirable.

### PRINCIPAL OBJECTS OF THE INVENTION

It is a main object of the present invention to provide an element that complies with ADA requirements.

It is another object of the present invention to provide an element that complies with ADA requirements and which can be expeditiously installed.

It is another object of the present invention to provide a warning that complies with the requirements of the ADA yet which is not overly-burdensome to install.

It is another object of the present invention to provide a warning that complies with the requirements of the ADA yet which is easy to install, maintain, and replace.

It is another object of the present invention to provide a warning that complies with the requirements of the ADA yet which is easy to install, maintain and replace, and is still easy to see and can be attractive if desirable.

### SUMMARY OF THE INVENTION

These, and other, objects are achieved by an element that has a body which is mounted in a substrate and which has a bore defined therethrough. A head that is one-piece with the body also has a bore defined therethrough and which is aligned with the bore defined through the body. An expander pin is accommodated in the aligned bores to secure the element to the substrate and has a head that has a color that contrasts with the color of the substrate so it is very visible and complies with the requirements of the Americans With Disabilities Act (ADA).

Using the element embodying the present invention will permit ramps and the like to be formed in a manner that complies with the ADA while also being expeditious to install and maintain.

### BRIEF DESCRIPTION OF THE DRAWING FIGURES

FIG. 1 is a perspective view of an element embodying the present invention.

FIG. 2 is an elevational view of the element shown in FIG. 1 as seen along line 2-2 of FIG. 1.

FIG. 3 is a top plan view of an assembled element embodying the present invention.

FIG. 4 is a top plan view of a layout showing a plurality of elements in place in a substrate.

FIG. 5 is an elevational view of an element in an assembled condition in a support.

FIG. 6 is an elevational view of a plurality of elements installed in a support.

### DETAILED DESCRIPTION OF THE PREFERRED EMBODIMENT

Other objects, features and advantages of the invention will become apparent from a consideration of the following detailed description and the accompanying drawings.

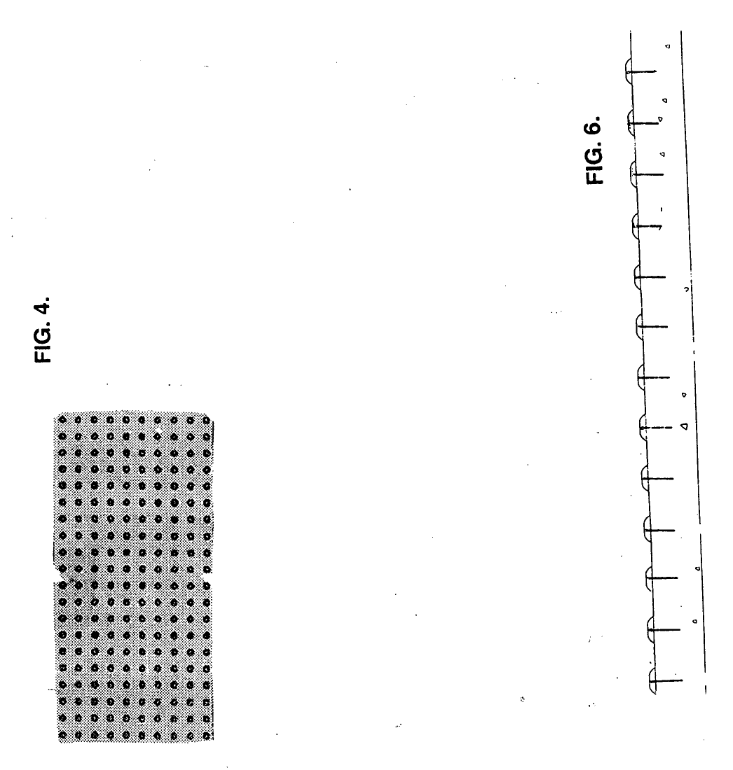

Referring to the Figures, it can be understood that the present invention is embodied in an element 10 that is used in a support, such as ground G in a manner that complies with the requirements of the ADA. The elements can be placed in a pattern such as shown in FIGS. 4 and 6.

Element 10 comprises an element body 12 that has a cylindrical base 14 with a first end 16 that is a bottom end when element body 14 is in use in a substrate, such as shown in FIGS. 5 and 6, a second end 18 that is a top end when element body 12 is in use, and a longitudinal axis 20 which extends between first end 16 and second end 18. Cylindrical base 14 has an outer dimension D1 and a bore 30 defined therethrough in the direction of longitudinal axis 20. Bore 30 extends between first end 16 and second end 18 and has an internal dimension D2.

A head 40 is one-piece with element body 12 and is located on first end 16. Head 40 has an outer dimension D3 that is greater than outer dimension D1 of cylindrical base 14. Head 40 further includes a first face 44 that is a top face when head 40 is in use, a second face 46 that is a bottom face when head 40 is in use, and a longitudinal axis 48 that extends between first face 44 and second face 46. A bore 50 extends between first face 44 and second face 46 and is aligned with bore 30 defined in cylindrical base 14. Bore 50 has an internal dimension D4 that is identical to internal dimension D2 of bore 30.

Head 40 of the element body 12 has a color, indicated by line 60, that is selected according to a contrast percent determined according to C=100{(B1−B2)/B1}, where C=contrast, B1=light reflectance value (LRV) of head 40 of element body 12 and B2=light reflectance value (LRV) of substrate G in which element body 12 is located.

An expander pin 70 is adapted to be accommodated in aligned bores 30 and 50. Expander pin 70 includes a body 72 having a first end 74 that is a top end when expander pin 70 is in use, a second end 76 that is a bottom end when expander pin 70 is in use, and a longitudinal axis 78 which extends between first end 74 and second end 76. Expander pin body 72 has an outer dimension D5 that is smaller than inner dimensions D2 and D4. Longitudinal axis 78 of element body 12 is co-linear with aligned longitudinal axes 20 and 48 when expander pin 70 is in use.

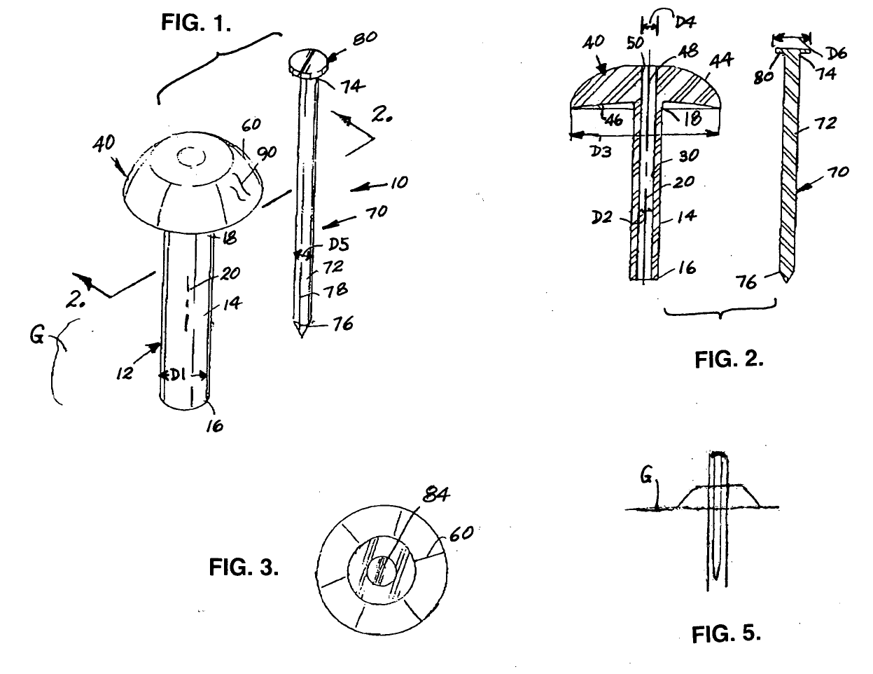

A head 80 is located on first end 74 of body 72 of expander pin 70 and has an outer dimension D6 that is greater than outer dimension D5 of body 72. The element can also have a special textured surface, such as surface 90 indicated in FIG. 1.

It is to be understood that while certain forms of the present invention have been illustrated and described herein, it is not to be limited to the specific forms or arrangements of parts described and shown.

1. An element comprising:
(a) an element body having a cylindrical base with a first end that is a bottom end when said element body is in use in a substrate, a second end that is a top end when said element body is in use, and a longitudinal axis which extends between the first end and the second end, the cylindrical base having an outer dimension and a bore defined therethrough in the direction of the longitudinal axis, the bore extending between the first end and the second end and having an internal dimension;
(b) a head that is one-piece with said element body and is located on the first end of said element body, the head having
(1) an outer dimension that is greater than the outer dimension of the cylindrical base of said element body,
(2) a first face that is a top face when said head is in use,
(3) a second face that is a bottom face when said head is in use,
(4) a longitudinal axis that extends between the first face and the second face,
(5) a bore extending between the first face and the second face and which is aligned with the bore defined in the cylindrical base of said element body, the bore of said head having an internal dimension that is identical to the internal dimension of the bore of said head, and
(6) the head of the element body having a color that is selected according to a contrast percent determined according to C=100{(B1−B2)/B1}, where C=contrast, B1=light reflectance value (LRV) of the head of said body and B2=light reflectance value (LRV) of the substrate in which said element body is located; and
(c) an expander pin which is adapted to be accommodated in the aligned bores of said element body and said head, said expander pin including
(1) a body having a first end that is a top end when said expander pin is in use, a second end that is a bottom end when said expander pin is in use, a longitudinal axis which extends between the first end of the body of said expander pin and the second end of the body of said expander pin, and an outer dimension that is smaller than the inner dimensions of the aligned bores of the body of said head and the base of said element body, the longitudinal axis of the body of said expander pin being co-linear with the aligned longitudinal axes of the aligned bores of said element body and said head when said expander pin is in use, and
(2) a head on the first end of the body of said expander pin, the head of said expander pin having an outer dimension that is greater than the outer dimension of the body of said expander pin, the head having a color that is identical to the color of the head of the body of said element.

2. The element as described in claim 1 wherein B1 is less than 100 and B2 is greater than zero.

3. The element as described in claim 1 further including a screw thread thereon on the base of said element body.
